(19) United States
(12) Patent Application Publication
(10) Pub. No.: US 2026/0208627 A1
(43) Pub. Date: Jul. 23, 2026

(54) CONTROL DEVICE, SYSTEM, NON-TRANSITORY STORAGE MEDIUM, AND CONTROL METHOD

(71) Applicant: TOYOTA JIDOSHA KABUSHIKI KAISHA, Toyota-shi (JP)

(72) Inventor: Keizoh KAWAGUCHI, Okazaki-shi (JP)

(73) Assignee: TOYOTA JIDOSHA KABUSHIKI KAISHA, Toyota-shi (JP)

(21) Appl. No.: 19/435,510

(22) Filed: Dec. 29, 2025

(30) Foreign Application Priority Data
Jan. 20, 2025 (JP) 2025-008080

(51) Int. Cl. B60L 58/27

(52) U.S. Cl. CPC B60L 58/27; B60L 2240/545; B60L 2240/662; B60L 2250/16; B60L 2260/58

(57) ABSTRACT

A control device includes a communication unit that communicates with a vehicle and a terminal device, and a control unit. The control unit is configured to: acquire temperature information of a storage battery of the vehicle and ambient temperature information of the vehicle, when, after the temperature of the storage battery has risen to a temperature higher than a first temperature, stop information is received from the vehicle through the communication unit; based on the temperature information and the ambient temperature information, predict a reaching time at which the temperature of the storage battery will have decreased to reach the first temperature; and at or before the reaching time, transmit, to the terminal device through the notification unit, notification information that proposes sending a command for re-raising the temperature of the storage battery to the vehicle.

### CROSS-REFERENCE TO RELATED APPLICATION

This application claims priority to Japanese Patent Application No. 2025-008080 filed on January 20, 2025. The disclosure of the above-identified application, including the specification, drawings, and claims, is incorporated by reference herein in its entirety.

### BACKGROUND

### 1. Technical Field

The present disclosure relates to a control device, a system, a non-transitory storage medium, and a control method.

### 2. Description of Related Art

There has been hitherto a technology that manages the temperature of a storage battery of a vehicle to enhance the performance of the storage battery at low temperatures. For example, Japanese Unexamined Patent Application Publication No. 2019-46737 (JP 2019-46737 A) discloses deriving temperature maintaining electricity and temperature re-raising electricity based on a predicted departure time of a vehicle, and selecting one of maintaining the temperature and re-raising the temperature of an electricity storage device for which a heater consumes less electricity.

### SUMMARY

Maintaining the temperature of an electricity storage device is inefficient in terms of electricity consumption. A technology that manages the once-raised temperature of a storage battery of a vehicle has room for improvement.

The present disclosure provides a control device, a system, a non-transitory storage medium, and a control method that improve the technology that manages the once-raised temperature of a storage battery of a vehicle.

A system according to one embodiment of the present disclosure includes: a vehicle including a storage battery and a heater; a control device; and a terminal device that a user uses to remotely control the vehicle. The control device is configured to: receive, from the vehicle, temperature information indicating a temperature of the storage battery detected by a storage battery temperature sensor included in the vehicle and ambient temperature information indicating an ambient temperature of the vehicle detected by an ambient temperature sensor included in the vehicle, when, after the temperature of the storage battery has risen to a temperature higher than a first temperature, stop information indicating stop of the temperature rise of the storage battery is received from the vehicle; based on the temperature information and the ambient temperature information, predict a reaching time at which the temperature of the storage battery will have decreased to reach the first temperature; and at or before the reaching time, transmit, to the terminal device, notification information that proposes sending a command for re-raising the temperature of the storage battery to the vehicle. The terminal device is configured to: receive the notification information from the control device and output the notification information to the user; and upon accepting a user command for re-raising the temperature of the storage battery, transmit a command for raising the temperature of the storage battery to the vehicle. The vehicle is configured to, upon receiving the command for raising the temperature from the terminal device, raise the temperature of the storage battery using the heater.

A system according to another embodiment of the present disclosure includes the control device and the terminal device.

The terminal device may be configured to receive the notification information from the control device, and to output, to the user, the notification information along with an operation image that accepts the command.

A control device according to one embodiment of the present disclosure includes a communication unit that communicates with a vehicle including a storage battery and with a terminal device that a user uses to remotely control the vehicle, and a control unit configured to: acquire temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle through the communication unit; based on the temperature information and the ambient temperature information, predict a reaching time at which the temperature of the storage battery will have decreased to reach the first temperature; and at or before the reaching time, transmit, to the terminal device through the communication unit, notification information that proposes sending a command for re-raising the temperature of the storage battery to the vehicle.

The control unit may be configured to predict a departure time of the vehicle and a required time that is taken to re-raise the temperature of the storage battery such that the temperature of the storage battery reaches a second temperature higher than the first temperature, and to transmit the notification information at a time earlier than the departure time by the required time.

The control unit may be configured to acquire schedule information of the user and predict the departure time based on the schedule information.

The control unit may be configured to acquire terminal position information indicating a position of the terminal device and vehicle position information indicating a position of the vehicle, and to predict the departure time such that the farther the position of the terminal device and the position of the vehicle are away from each other, the later the departure time is.

The control unit may be configured to predict the required time such that the lower the ambient temperature is, the longer the required time is.

The control unit may be configured to predict a decrease start time at which the temperature of the storage battery will start to decrease, and to transmit the notification information to the terminal device through the communication unit at the decrease start time.

The control unit may be configured to transmit boarding proposal information that proposes boarding the vehicle before the decrease start time to the terminal device through the communication unit at a time before the decrease start time.

The control unit may be configured to receive, through the communication unit, the ambient temperature information from a server device that provides weather information.

A program according to one embodiment of the present disclosure may cause a computer to function as the control device.

A control method according to one embodiment of the present disclosure is a control method executed by a control device, including: communicating with a vehicle including a storage battery and with a terminal device that a user uses to remotely control the vehicle; acquiring temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle; based on the temperature information and the ambient temperature information, predicting a reaching time at which the temperature of the storage battery will have decreased to reach the first temperature; and at or before the reaching time, transmitting, to the terminal device, notification information that proposes sending a command for re-raising the temperature of the storage battery to the vehicle.

The control method may further include: predicting a departure time of the vehicle and a required time that is taken to re-raise the temperature of the storage battery such that the temperature of the storage battery reaches a second temperature higher than the first temperature; and transmitting the notification information at a time earlier than the departure time by the required time.

The control method may further include acquiring schedule information of the user and predicting the departure time based on the schedule information.

The control method may further include: acquiring terminal position information indicating a position of the terminal device and vehicle position information indicating a position of the vehicle; and predicting the departure time such that the farther the position of the terminal device and the position of the vehicle are away from each other, the later the departure time is.

The control method may further include predicting the required time such that the lower the ambient temperature is, the longer the required time is.

The control method may further include predicting a decrease start time at which the temperature of the storage battery will start to decrease, and transmitting the notification information at the decrease start time.

The control method may further include transmitting boarding proposal information that proposes boarding the vehicle before the decrease start time to the terminal device at a time before the decrease start time.

The control method may further include receiving the ambient temperature information from a server device that provides weather information.

One embodiment of the present disclosure is a non-transitory storage medium storing instructions that are executable by one or more processors and that cause the one or more processors to perform the following functions: communicating with a vehicle including a storage battery and with a terminal device that a user uses to remotely control the vehicle; acquiring temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle; based on the temperature information and the ambient temperature information, predicting a reaching time at which the temperature of the storage battery will have decreased to reach the first temperature; and at or before the reaching time, transmitting, to the terminal device, notification information that proposes sending a command for re-raising the temperature of the storage battery to the vehicle.

One embodiment of the present disclosure improves the technology that manages the once-raised temperature of a storage battery of a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view showing a simplified configuration of a management system according to a first embodiment;

FIG. 2A is a flowchart showing an example of the operation of the management system according to the first embodiment;

FIG. 2B is a flowchart showing an example of the operation of the management system according to the first embodiment;

FIG. 3A is a flowchart showing an example of the operation of a management system according to a second embodiment; and

FIG. 3B is a flowchart showing an example of the operation of the management system according to the second embodiment.

### DETAILED DESCRIPTION OF EMBODIMENTS

### First Embodiment

In the following, a first embodiment of the present disclosure will be described with reference to the drawings.

The same or equivalent parts are denoted by the same reference signs throughout the drawings. In the description of this embodiment, the description of the same or equivalent parts will be omitted or simplified as appropriate.

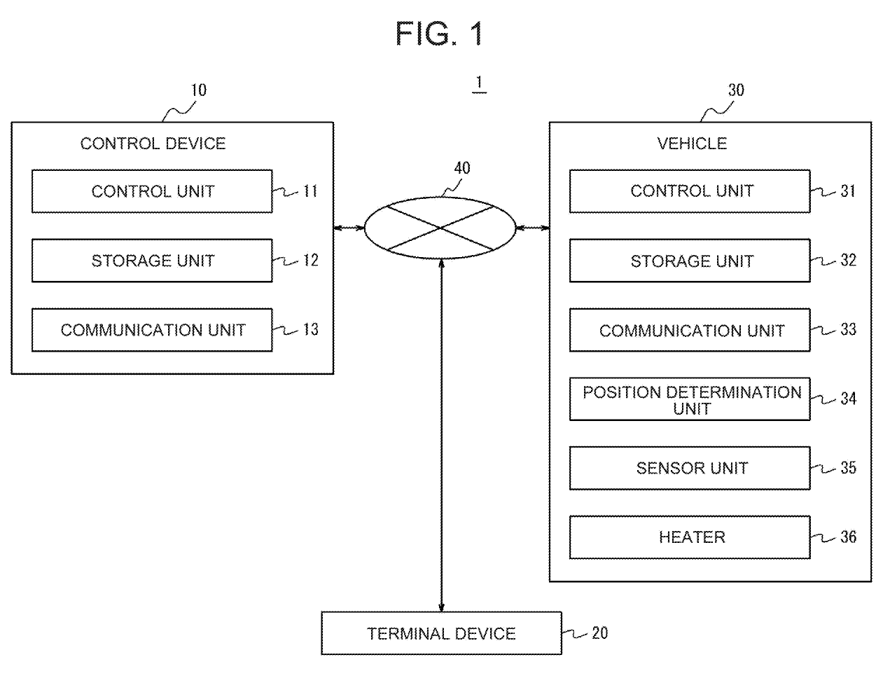

The configuration of a management system 1 according to this embodiment will be described with reference to FIG. 1. The management system 1 includes a control device 10, a terminal device 20, and a vehicle 30. The control device 10, the terminal device 20, and the vehicle 30 are communicable with one another through a network 40.

The control device 10 is, for example, a general-purpose computer such as a PC or a tablet, a server computer such as a cloud server, or a special-purpose computer. "PC" is an abbreviation of "personal computer."

The terminal device 20 is an arbitrary device used by a user. For example, a general-purpose electronic device such as a smartphone, a tablet terminal, or a wearable terminal, or a special-purpose electronic device can be adopted as the terminal device 20. The terminal device 20 includes a control unit that controls the operation of each unit, a communication unit that communicates with an external device, an input-output unit, and a position determination unit that determines the position of the terminal device 20. The input-output unit includes, for example, a touch panel display etc.

The vehicle 30 is a vehicle equipped with a storage battery. The vehicle 30 is, for example, an automobile equipped with a storage battery for drive, such as an HEV, a PHEV, or a BEV. "HEV" is an abbreviation of "hybrid electric vehicle." "PHEV" is an abbreviation of "plug-in hybrid electric vehicle." "BEV" is an abbreviation of "battery electric vehicle." The vehicle 30 may be driven by a driver, or the driving may be automated at an arbitrary level. The automation level is, for example, one of Level 1 to Level 5 in the level classification by SAE. "SAE" is an abbreviation of "Society of Automotive Engineers." The vehicle 30 may be a vehicle dedicated to MaaS. "MaaS" is an abbreviation of "Mobility as a Service."

The network 40 includes the Internet, at least one WAN, at least one MAN, or a combination of these. "WAN" is an abbreviation of "wide area network." "MAN" is an abbreviation of "metropolitan area network." The network 40 may include at least one wireless network, at least one optical network, or a combination of these. The wireless network is, for example, an ad hoc network, a cellular network, a wireless LAN, a satellite communications network, or a terrestrial microwave network. "LAN" is an abbreviation of "local area network."

This embodiment will be described first in outline and later in detail. The control device 10 of the management system 1 communicates with the vehicle 30 including a storage battery and with the terminal device 20 that the user uses to remotely control the vehicle 30. The control device 10 acquires temperature information indicating a temperature of the storage battery and ambient temperature information indicating an ambient temperature of the vehicle 30, when, after the temperature of the storage battery has risen to a temperature higher than a first temperature, stop information indicating stop of the temperature rise of the storage battery is received from the vehicle 30. Based on the temperature information and the ambient temperature information, the control device 10 predicts a reaching time at which the temperature of the storage battery will have decreased to reach the first temperature. At or before the reaching time, the control device 10 transmits, to the terminal device 20, notification information that proposes sending a command for re-raising the temperature of the storage battery to the vehicle 30.

The vehicle 30 has a function (hereinafter referred to as "battery preconditioning") that raises the temperature of the storage battery by a heater 36 before departure according to a command from the terminal device 20 to thereby improve the efficiency of charge or discharge. The first temperature is a temperature at which the temperature of the storage battery has become so low that the efficiency of charge or discharge decreases. The first temperature may be set beforehand. This embodiment makes it possible to propose battery preconditioning to the user by grasping beforehand a timing when re-raising of the temperature is required. The user who has seen the notification information sends a user command for raising the temperature to the vehicle 30, which prevents the temperature of the storage battery from decreasing to the first temperature again, thereby allowing the storage battery to maintain its performance. Thus, the technology that manages the once-raised temperature of the storage battery of the vehicle 30 is improved.

Next, the configuration of each of the control device 10 and the vehicle 30 of the management system 1 will be described in detail.

### Configuration of Control Device

As shown in FIG. 1, the control device 10 includes a control unit 11, a storage unit 12, and a communication unit 13.

The control unit 11 includes one or more processors, one or more programmable circuits, one or more dedicated circuits, or a combination of these. Examples of processors include, but are not limited to, general-purpose processors such as a central processing unit (CPU) and a graphics processing unit (GPU), and special-purpose processors specialized for specific processing. Examples of programmable circuits include, but are not limited to, a field-programmable gate array (FPGA). Examples of dedicated circuits include, but are not limited to, an application-specific integrated circuit (ASIC). The control unit 11 controls the operation of the entire control device 10.

The storage unit 12 includes one or more memories. Examples of memories include, but are not limited to, a semiconductor memory, a magnetic memory, and an optical memory. Each memory included in the storage unit 12 may function as, for example, a main storage device, an auxiliary storage device, or a cache memory. The storage unit 12 stores arbitrary information used for the operation of the control device 10. For example, the storage unit 12 may store a system program, an application program, built-in software, etc. Information stored in the storage unit 12 may be updatable by, for example, information acquired from the network 40 through the communication unit 13.

The communication unit 13 includes one or more communication interfaces that are connected to the network 40. This communication interface complies with, for example, a mobile communications standard such as 4th Generation (4G) or 5th Generation (5G), a wired LAN standard, or a wireless LAN standard, but is not limited to these and may comply with an arbitrary communications standard.

The functions of the control device 10 are realized as a program according to this embodiment is executed by a processor equivalent to the control unit 11. That is, the functions of the control device 10 are realized by software. The program causes a computer to execute the operation of the control device 10 and thereby causes the computer to function as the control device 10. That is, the computer functions as the control device 10 by executing the operation of the control device 10 in accordance with the program. In this embodiment, the program can be recorded in a computer-readable recording medium. Examples of computer-readable recording media include non-transitory computer-readable media, such as a magnetic recording device and a semiconductor memory. Some or all of the functions of the control device 10 may be realized by a dedicated circuit equivalent to the control unit 11. That is, some or all of the functions of the control device 10 may be realized by hardware.

### Configuration of Vehicle

As shown in FIG. 1, the vehicle 30 includes a control unit 31, a storage unit 32, a communication unit 33, a position determination unit 34, a sensor unit 35, and the heater 36 mentioned above.

The control unit 31 includes at least one processor, at least one programmable circuit, at least one dedicated circuit, at least one electronic control unit (ECU), or an arbitrary combination of these. The processor is a general-purpose processor such as a CPU or a GPU, or a special-purpose processor specialized for specific processing. Examples of programmable circuits include an FPGA. Examples of dedicated circuits include an ASIC. The control unit 31 executes processing relating to the operation of the vehicle 30 while controlling each part of the vehicle 30.

The storage unit 32 includes at least one semiconductor memory, at least one magnetic memory, at least one optical memory, or an arbitrary combination of these. Examples of semiconductor memories include a RAM and a ROM. Examples of RAMs include a SRAM and a DRAM. Examples of ROMs include an EEPROM. The storage unit 32 functions as, for example, a main storage device, an auxiliary storage device, or a cache memory. In the storage unit 32, data used for the operation of the vehicle 30 and data obtained by the operation of the vehicle 30 are stored.

The communication unit 33 includes at least one communication interface. The communication interface is, for example, an interface compatible with a mobile communications standard such as LTE, the 4G standard, or the 5G standard, an interface compatible with near-field communication such as Bluetooth (R), or an LAN interface. The communication unit 33 receives data used for the operation of the vehicle 30 and transmits data obtained by the operation of the vehicle 30.

The position determination unit 34 includes a receiver that is compatible with a satellite positioning system, such as the Global Positioning System (GPS) or the Global Navigation Satellite System (GNSS). The sensor unit 35 includes an ambient temperature sensor that detects the ambient temperature, a storage battery temperature sensor that detects the temperature of the storage battery, and other sensors. The sensor unit 35 outputs a detected value to the control unit 31. The heater 36 includes a heating element provided around or on a surface of the storage battery, and can prevent the temperature of the storage battery from becoming low by transferring heat to the storage battery and thus raising the temperature of the storage battery.

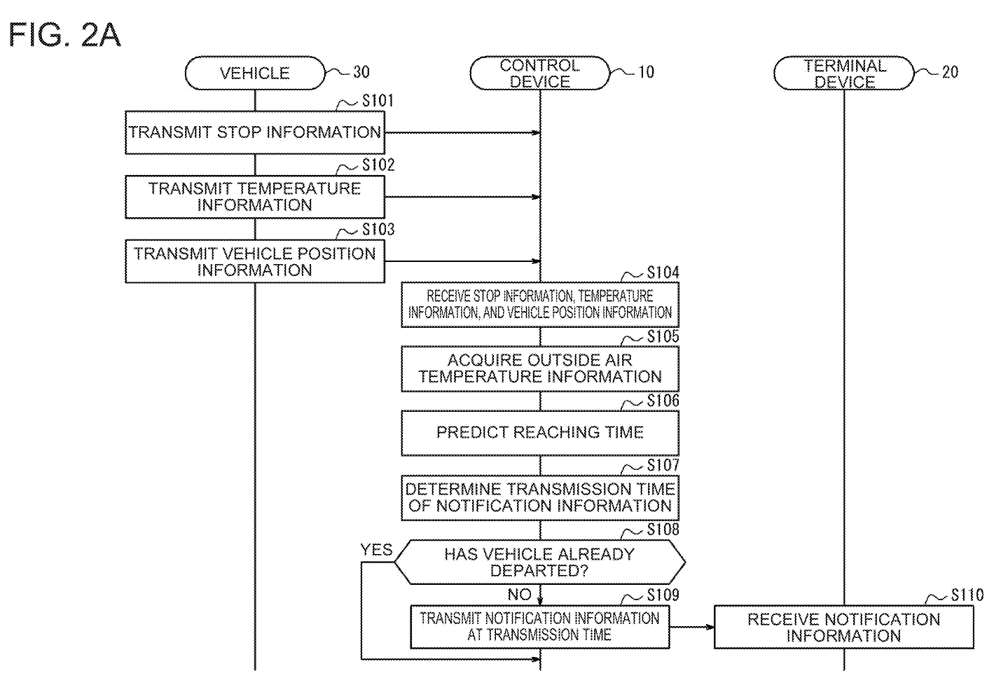

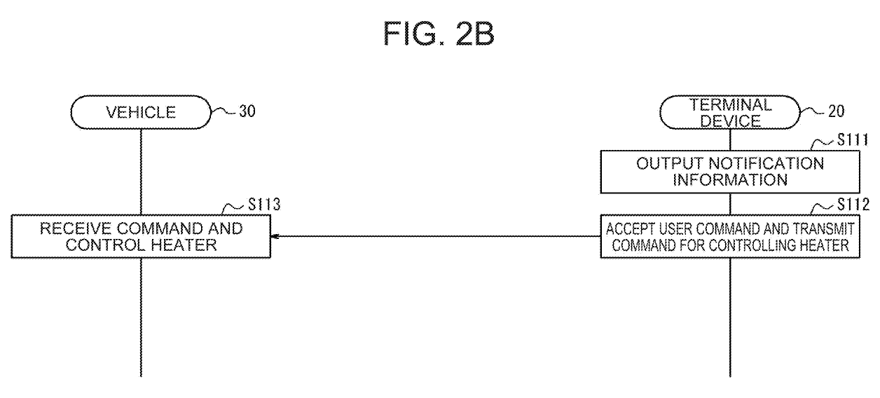

The operation of the management system 1 according to this embodiment will be described with reference to FIG. 2A and FIG. 2B. Of the operation of the management system 1, the operation of the control device 10 is equivalent to a control method according to this embodiment. In the following, the control device 10 performs transmission and reception of information to and from the vehicle 30 and the terminal device 20 through the communication unit 13 and the network 40. In the following, the terminal device 20 performs transmission and reception of information to and from the control device 10 and the vehicle 30 through the communication unit and the network 40. In the following, the vehicle 30 performs transmission and reception of information to and from the control device 10 and the terminal device 20 through the communication unit 33 and the network 40. The following operation starts when the vehicle 30 stops the operation of the heater 36 after raising the temperature of the storage battery to a temperature higher than the first temperature by the heater 36, i.e., when battery preconditioning is once executed and then stopped. The following operation may start when the vehicle 30 that is traveling stops after the temperature of the storage battery of the vehicle 30 has reached a temperature higher than the first temperature due to heat generation of the storage battery itself.

In S101, the control unit 31 of the vehicle 30 transmits stop information indicating stop of a temperature rise of the storage battery to the control device 10. The control unit 31 may generate the stop information upon detecting that the rise in the temperature of the storage battery has stopped based on a value output from the storage battery temperature sensor. Without being limited thereto, the control unit 31 may generate the stop information when a current applied to the heater 36 stops. The control unit 31 may generate the stop information and transmit it to the control device 10 when the position of the vehicle 30 detected by the position determination unit 34 is not a predetermined place and moreover it is detected that the rise in the temperature of the storage battery has stopped. The predetermined place is a place where the vehicle 30 is parked for a long period of time, for example, a parking space at the user's house. The predetermined place may be set and stored in the storage unit 32 beforehand.

In S102, the control unit 31 of the vehicle 30 transmits, to the control device 10, temperature information indicating the temperature of the storage battery detected by the storage battery temperature sensor. The control unit 31 may transmit the temperature information to the control device 10 at all times or may transmit it upon request from the control device 10.

In S103, the control unit 31 transmits vehicle position information indicating the position of the vehicle 30 to the control device 10.

In S104, the control unit 11 of the control device 10 receives the stop information, the temperature information, and the vehicle position information.

In S105, the control unit 11 of the control device 10 acquires the ambient temperature information indicating an air temperature outside the vehicle 30. The control unit 11 may receive the ambient temperature information from the vehicle 30, or may receive it from a server device that provides weather information. When receiving the ambient temperature information from a server device, the control unit 11 may receive the vehicle position information indicating the position of the vehicle 30 from the vehicle 30, and may acquire the ambient temperature information by referring to weather information on a region corresponding to that position.

In S106, based on the temperature information and the ambient temperature information, the control unit 11 predicts a reaching time at which the temperature of the storage battery of the vehicle 30 will have decreased to reach the first temperature. The first temperature may be set and stored in the storage unit 12 beforehand. The control unit 11 may refer to information in which a rate of decrease of the temperature of the storage battery and the ambient temperature are associated with each other, and may predict the reaching time based on this information and the ambient temperature information. The control unit 11 may predict the reaching time such that the lower the ambient temperature is, the nearer in the future the reaching time is. The control unit 11 may predict the reaching time such that the larger the difference between the temperature of the storage battery indicated by the temperature information and the ambient temperature is, the nearer in the future the reaching time is.

In S107, the control unit 11 determines transmission time for transmitting, to the terminal device 20, notification information that proposes sending a command for re-raising the temperature of the storage battery to the vehicle 30. The control unit 11 may determine, as the transmission time, a time before the reaching time (hereinafter referred to as "first time"). The control unit 11 determines, as the transmission time, for example, a time 15 minutes, 30 minutes, or one hour before the reaching time.

In S108, based on the vehicle position information, the control unit 11 determines whether the vehicle 30 has already departed. When it is determined that the vehicle 30 has already departed, the storage battery will be raised in temperature by being discharged, which makes it unnecessary to raise the temperature by the heater 36. Therefore, the operation of the management system 1 ends. When it is determined that the vehicle 30 has not yet departed, the operation of the management system 1 proceeds to S109.

In S109, the control unit 11 generates the notification information, and transmits the notification information to the terminal device 20 at the first time that has been determined as the transmission time.

In S110, the terminal device 20 receives the notification information.

In S111, the terminal device 20 outputs the notification information through the input-output unit. The terminal device 20 may output, along with the notification information, an operation image that accepts a user command. By performing an operation such as tapping on this operation image, the user can easily input a user command. This improves the convenience for the user in sending a command for battery preconditioning to the vehicle 30.

In S112, the terminal device 20 accepts the user command for controlling the heater 36 of the vehicle 30, and transmits a command for controlling the heater 36 to the vehicle 30. That is, the terminal device 20 transmits a command for battery preconditioning to the vehicle 30.

In S113, the control unit 31 of the vehicle 30 receives the command from the terminal device 20 and controls the heater 36 according to the command. The control unit 31 executes battery preconditioning by operating the heater 36 so as to raise the temperature of the storage battery. Thereafter, the operation of the management system 1 ends.

In this embodiment, energy for re-raising the temperature can be input at a truly necessary timing, namely before the first temperature is reached, which allows for higher efficiency of electricity consumption than continuing to maintain the temperature of the storage battery.

### Second Embodiment

In the following, a second embodiment of the present disclosure will be described. In the first embodiment, the control unit 11 determines, as the transmission time of the notification information, the first time that is a time a predetermined time before the reaching time, whereas in this embodiment, the control unit 11 determines, as the transmission time, a time that is before the reaching time and is earlier than the predicted departure time of the vehicle 30 by a required time.

The configuration of the management system 1 according to this embodiment is the same as that in the first embodiment; therefore the description thereof will be omitted.

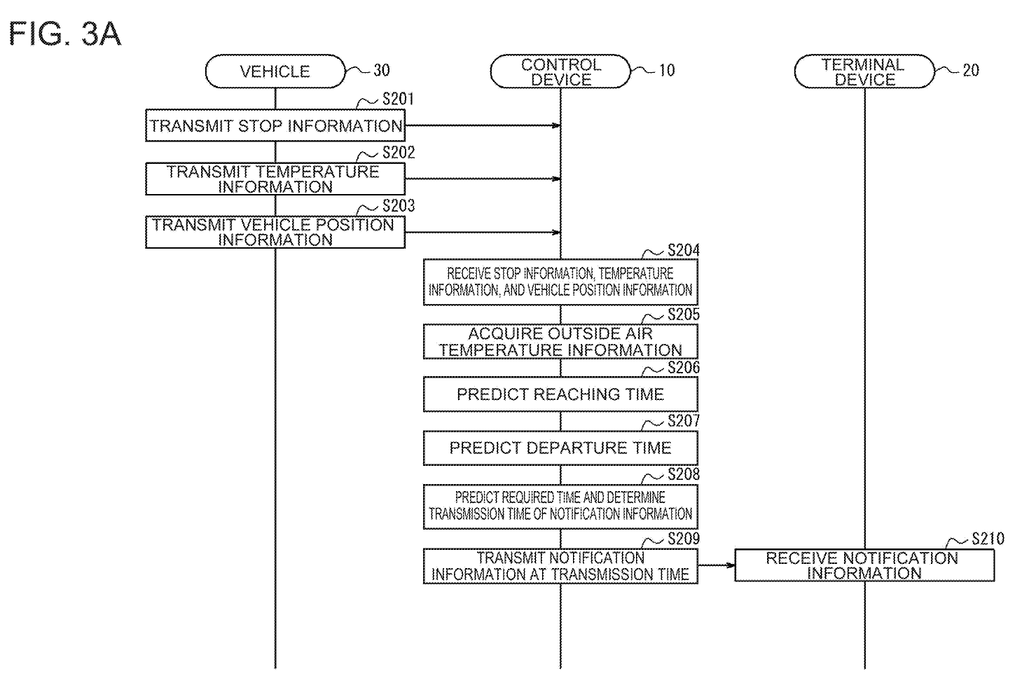

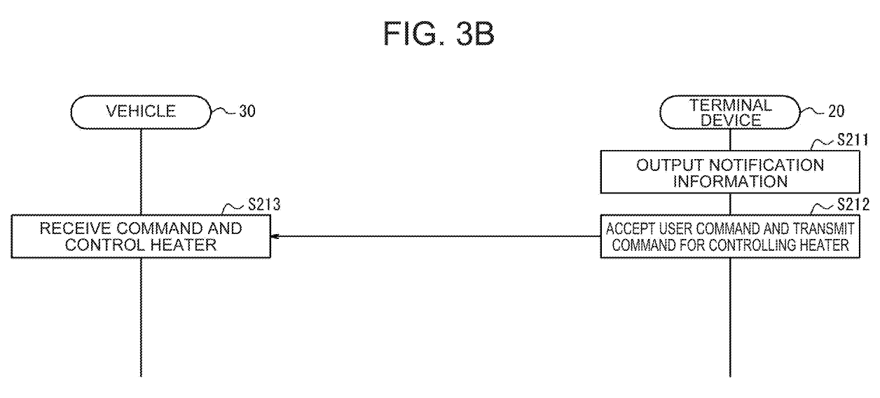

The operation of the management system 1 according to the second embodiment will be described with reference to FIG. 3A and FIG. 3B.

S201 to S206 are the same as S101 to S106 described above; therefore the description thereof will be omitted.

In S207, the control unit 11 of the control device 10 predicts the departure time at which the user is expected to board the vehicle 30 and depart. For the prediction of the departure time, an arbitrary technique may be adopted. For example, the control unit 11 further acquires terminal position information indicating the position of the terminal device 20. The control unit 11 may predict the departure time such that the farther the position of the terminal device 20 is away from the position of the vehicle 30, the later the departure time is, and may predict the departure time such that the nearer the position of the terminal device 20 is to the position of the vehicle 30, the nearer in the future the departure time is. The control unit 11 may refer to a history of past departure times of the vehicle 30 that is stored in the storage unit 12, and may predict, as the departure time, the same time as a past departure time. The control unit 11 may acquire schedule information indicating the user's schedule and predict the departure time based on the schedule information. For example, the control unit 11 may calculate, by a route search, a time required for traveling between a place where the user has a next engagement and a place where the vehicle 30 is stopped, and may predict, as the departure time, time earlier than start time of the next engagement by that required time.

In S208, the control unit 11 predicts a required time that is taken to re-raise the temperature of the storage battery such that the temperature of the storage battery reaches a second temperature higher than the first temperature. The control unit 11 determines a time earlier than the departure time by the required time (hereinafter referred to as "second time") as the transmission time for transmitting the notification information to the terminal device 20. The second temperature is a temperature at which the storage battery can be efficiently charged or discharged. The second temperature may be set and stored in the storage unit 12 beforehand. In the first embodiment, since the departure time is not predicted, the second temperature is not taken into account. In this embodiment, the second temperature is taken into account according to the predicted departure time, so that the temperature of the storage battery can be more proactively raised in advance. While the notification information is, as in the first embodiment, information that proposes sending a command for re-raising the temperature of the storage battery to the vehicle 30, in this embodiment, the notification information may include the departure time predicted in S207 itself. The control unit 11 may refer to information in which a rate at which the heater 36 raises the temperature of the storage battery and the ambient temperature are associated with each other, and may predict the required time based on this information and the ambient temperature information. The control unit 11 may predict the required time such that the lower the ambient temperature indicated by the ambient temperature information is, the longer the required time is.

In S209, the control unit 11 generates the notification information, and transmits the notification information to the terminal device 20 at the second time that has been determined as the transmission time.

S210 to S213 are the same as S110 to S113 described above; therefore the description thereof will be omitted.

In this embodiment, a notification is output so as to coincide with a timing when the user boards the vehicle 30, and the temperature of the storage battery can be re- raised to the second temperature. This can reduce the likelihood that the user may feel annoyed as a notification comes despite there being still time until departure.

As one modified example, the control unit 11 may further predict a decrease start time at which the temperature of the storage battery will start to decrease, and may determine the decrease start time as the transmission time for transmitting the notification information to the terminal device 20. In this case, the control unit 11 predicts the decrease start time based on the ambient temperature indicated by the ambient temperature information. For example, the control unit 11 may predict the decrease start time such that the lower the ambient temperature is, the nearer in the future the decrease start time is. The control unit 11 may further generate boarding proposal information that proposes boarding the vehicle 30 before the decrease start time. In this case, the control unit 11 transmits the boarding proposal information to the terminal device 20 at a time before the decrease start time. The time before the decrease start time may be arbitrarily set, like, for example, 10 minutes or 30 minutes before the decrease start time. This modified example makes it possible to propose battery preconditioning to the user at an earlier stage. As the user who has seen the boarding proposal information boards the vehicle 30 before the decrease start time, heat that has been used to once raise the temperature of the storage battery can be used without being wasted.

As one modified example, the control unit 11 may monitor the temperature of the storage battery based on the temperature information, and may transmit the notification information when this temperature reaches a predetermined temperature higher than the first temperature. The predetermined temperature may be set and stored in the storage unit 12 beforehand.

The present disclosure is not limited to the embodiments described above. For example, two or more blocks depicted in the block diagram may be integrated or one block may be divided. Instead of executing two or more steps depicted in the flowcharts in chronological order in accordance with the description, these steps may be executed concurrently or in a different order according to the processing capacity of a device that executes each step or according to the necessity. Other than the above, changes are possible without departing from the gist of the present disclosure.

In the following, some of embodiments of the present disclosure will be illustrated. However, it should be noted that embodiments of the present disclosure are not limited to these.

### Supplement 1

A system including: a vehicle including a storage battery and a heater; a control device; and a terminal device that a user uses to remotely control the vehicle,

wherein the control device:

receives, from the vehicle, temperature information indicating a temperature of the storage battery detected by a storage battery temperature sensor included in the vehicle and ambient temperature information indicating an ambient temperature of the vehicle detected by an ambient temperature sensor included in the vehicle, when, after the temperature of the storage battery has risen to a temperature higher than a first temperature, stop information indicating stop of the temperature rise of the storage battery is received from the vehicle;

based on the temperature information and the ambient temperature information, predicts a reaching time at which the temperature of the storage battery will have decreased to reach the first temperature; and

at or before the reaching time, transmits, to the terminal device, notification information that proposes sending a command for re-raising the temperature of the storage battery to the vehicle,

wherein the terminal device:

receives the notification information from the control device and outputs the notification information to the user; and

upon accepting a user command for re-raising the temperature of the storage battery, transmits a command for raising the temperature of the storage battery to the vehicle, and wherein, upon receiving the command for raising the temperature from the terminal device, the vehicle raises the temperature of the storage battery using the heater.

### Supplement 2

A control device including:

a communication unit that communicates with a vehicle including a storage battery and with a terminal device that a user uses to remotely control the vehicle; and

a control unit that:

acquires temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle through the communication unit;

based on the temperature information and the ambient temperature information, predicts a reaching time at which the temperature of the storage battery will have decreased to reach the first temperature; and

at or before the reaching time, transmits, to the terminal device through the communication unit, notification information that proposes sending a command for re-raising the temperature of the storage battery to the vehicle.

### Supplement 3

The control device according to Supplement 2, wherein the control unit predicts a departure time of the vehicle and a required time that is taken to re-raise the temperature of the storage battery such that the temperature of the storage battery reaches a second temperature higher than the first temperature, and transmits the notification information at a time earlier than the departure time by the required time.

### Supplement 4

The control device according to Supplement 3, wherein the control unit acquires schedule information of the user and predicts the departure time based on the schedule information.

### Supplement 5

The control device according to Supplement 3 or 4, wherein the control unit acquires terminal position information indicating a position of the terminal device and vehicle position information indicating a position of the vehicle, and predicts the departure time such that the farther the position of the terminal device and the position of the vehicle are away from each other, the later the departure time is.

### Supplement 6

The control device according to any one of Supplements 3 to 5, wherein the control unit predicts the required time such that the lower the ambient temperature is, the longer the required time is.

### Supplement 7

The control device according to any one of Supplements 2 to 6, wherein the control unit predicts a decrease start time at which the temperature of the storage battery will start to decrease, and transmits the notification information to the terminal device through the communication unit at the decrease start time.

### Supplement 8

The control device according to Supplement 7, wherein the control unit transmits boarding proposal information that proposes boarding the vehicle before the decrease start time to the terminal device through the communication unit at a time before the decrease start time.

### Supplement 9

The control device according to any one of Supplements 2 to 8, wherein the control unit receives, through the communication unit, the ambient temperature information from a server device that provides weather information.

### Supplement 10

A system including:

the control device according to any one of Supplements 2 to 9; and the terminal device.

### Supplement 11

The system according to Supplement 10, wherein the terminal device receives the notification information from the control device, and outputs, to the user, the notification information along with an operation image that accepts the command.

### Supplement 12

A program that causes a computer to function as the control device according to any one of Supplements 2 to 9.

### Supplement 13

A control method executed by a control device, including:

communicating with a vehicle including a storage battery and with a terminal device that a user uses to remotely control the vehicle;

acquiring temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle;

based on the temperature information and the ambient temperature information, predicting a reaching time at which the temperature of the storage battery will have decreased to reach the first temperature; and

at or before the reaching time, transmitting, to the terminal device, notification information that proposes sending a command for re-raising the temperature of the storage battery to the vehicle.

### Supplement 14

The control method according to Supplement 13, further including predicting a departure time of the vehicle and a required time that is taken to re-raise the temperature of the storage battery such that the temperature of the storage battery reaches a second temperature higher than the first temperature, and transmitting the notification information at a time earlier than the departure time by the required time.

### Supplement 15

The control method according to Supplement 14, further including acquiring schedule information of the user and predicting the departure time based on the schedule information.

### Supplement 16

The control method according to Supplement 14 or 15, further including:

acquiring terminal position information indicating a position of the terminal device and vehicle position information indicating a position of the vehicle; and

predicting the departure time such that the farther the position of the terminal device and the position of the vehicle are away from each other, the later the departure time is.

### Supplement 17

The control method according to any one of Supplements 14 to 16, further including predicting the required time such that the lower the ambient temperature is, the longer the required time is.

### Supplement 18

The control method according to any one of Supplements 13 to 17, further including predicting a decrease start time at which the temperature of the storage battery will start to decrease, and transmitting the notification information at the decrease start time.

### Supplement 19

The control method according to Supplement 18, further including transmitting boarding proposal information that proposes boarding the vehicle before the decrease start time to the terminal device at a time before the decrease start time.

### Supplement 20

The control method according to any one of Supplements 13 to 19, further including receiving the ambient temperature information from a server device that provides weather information.

What is claimed is:

1. A system comprising:
a vehicle including a storage battery and a heater;
a control device; and
a terminal device that a user uses to remotely control the vehicle,
wherein the control device is configured to:
receive, from the vehicle, temperature information indicating a temperature of the storage battery detected by a storage battery temperature sensor included in the vehicle and ambient temperature information indicating an ambient temperature of the vehicle detected by an ambient temperature sensor included in the vehicle, when, after the temperature of the storage battery has risen to a temperature higher than a first temperature, stop information indicating stop of the temperature rise of the storage battery is received from the vehicle;
based on the temperature information and the ambient temperature information, predict a reaching time at which the temperature of the storage battery will have decreased to reach the first temperature; and
at or before the reaching time, transmit, to the terminal device, notification information that proposes sending a command for re-raising the temperature of the storage battery to the vehicle,
wherein the terminal device is configured to:
receive the notification information from the control device and output the notification information to the user; and
upon accepting a user command for re-raising the temperature of the storage battery, transmit a command for raising the temperature of the storage battery to the vehicle, and
wherein the vehicle is configured to, upon receiving the command for raising the temperature from the terminal device, raise the temperature of the storage battery using the heater.

2. A control device comprising:
a communication unit that communicates with a vehicle including a storage battery and with a terminal device that a user uses to remotely control the vehicle; and
a control unit configured to:
acquire temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle through the communication unit;
based on the temperature information and the ambient temperature information, predict a reaching time at which the temperature of the storage battery will have decreased to reach the first temperature; and
at or before the reaching time, transmit, to the terminal device through the communication unit, notification information that proposes sending a command for re-raising the temperature of the storage battery to the vehicle.

3. The control device according to claim 2, wherein the control unit is configured to predict a departure time of the vehicle and a required time that is taken to re-raise the temperature of the storage battery such that the temperature of the storage battery reaches a second temperature higher than the first temperature, and to transmit the notification information at a time earlier than the departure time by the required time.

4. The control device according to claim 3, wherein the control unit is configured to acquire schedule information of the user and predict the departure time based on the schedule information.

5. The control device according to claim 3, wherein the control unit is configured to acquire terminal position information indicating a position of the terminal device and vehicle position information indicating a position of the vehicle, and predict the departure time such that the farther the position of the terminal device and the position of the vehicle are away from each other, the later the departure time is.

6. The control device according to claim 3, wherein the control unit is configured to predict the required time such that the lower the ambient temperature is, the longer the required time is.

7. The control device according to claim 2, wherein the control unit is configured to predict a decrease start time at which the temperature of the storage battery will start to decrease, and to transmit the notification information to the terminal device through the communication unit at the decrease start time.

8. The control device according to claim 7, wherein the control unit is configured to transmit boarding proposal information that proposes boarding the vehicle before the decrease start time to the terminal device through the communication unit at a time before the decrease start time.

9. The control device according to claim 2, wherein the control unit is configured to receive, through the communication unit, the ambient temperature information from a server device that provides weather information.

10. A system comprising:
the control device according to claim 2; and
the terminal device.

11. The system according to claim 10, wherein the terminal device is configured to receive the notification information from the control device, and to output, to the user, the notification information along with an operation image that accepts the command.

12. A non-transitory storage medium storing instructions that are executable by one or more processors and that cause the one or more processors to perform functions as the control device according to claim 2.

13. A control method executed by a control device, comprising:
communicating with a vehicle including a storage battery and with a terminal device that a user uses to remotely control the vehicle;
receiving temperature information indicating a temperature of the storage battery and ambient temperature information indicating an ambient temperature of the vehicle, when, after the temperature of the storage battery has risen to a temperature higher than a first temperature, stop information indicating stop of the temperature rise of the storage battery is received from the vehicle;
based on the temperature information and the ambient temperature information, predicting a reaching time at which the temperature of the storage battery will have decreased to reach the first temperature; and
at or before the reaching time, transmitting, to the terminal device, notification information that proposes sending a command for re-raising the temperature of the storage battery to the vehicle.

14. The control method according to claim 13, further comprising predicting a departure time of the vehicle and a required time that is taken to re-raise the temperature of the storage battery such that the temperature of the storage battery reaches a second temperature higher than the first temperature, and transmitting the notification information at a time earlier than the departure time by the required time.

15. The control method according to claim 14, further comprising acquiring schedule information of the user and predicting the departure time based on the schedule information.

16. The control method according to claim 14, further comprising:
acquiring terminal position information indicating a position of the terminal device and vehicle position information indicating a position of the vehicle; and
predicting the departure time such that the farther the position of the terminal device and the position of the vehicle are away from each other, the later the departure time is.

17. The control method according to claim 14, further comprising predicting the required time such that the lower the ambient temperature is, the longer the required time is.

18. The control method according to claim 13, further comprising predicting a decrease start time at which the temperature of the storage battery will start to decrease, and transmitting the notification information at the decrease start time.

19. The control method according to claim 18, further comprising transmitting boarding proposal information that proposes boarding the vehicle before the decrease start time to the terminal device at a time before the decrease start time.

20. The control method according to claim 13, further comprising receiving the ambient temperature information from a server device that provides weather information.
